(19) United States
(12) Patent Application Publication
(10) Pub. No.: US 2026/0159048 A1
(43) Pub. Date: Jun. 11, 2026

(54) SECONDARY BRAKING SYSTEMS FOR AUTONOMOUS VEHICLES

(71) Applicant: Torc Robotics, Inc., Blacksburg, VA (US)

(72) Inventors: Akshay Pai Raikar, Austin, TX (US); William Gray Davis, Austin, TX (US); Joseph R. Fox-Rabinovitz, Austin, TX (US)

(21) Appl. No.: 18/970,533

(22) Filed: Dec. 5, 2024

(51) Int. Cl. B60T 7/22; B60T 1/16; B60W 10/18; B60W 10/30; B60W 30/18; B62D 33/06

(52) U.S. Cl. CPC B60T 7/22; B60T 1/16; B60W 10/18; B60W 10/30; B60W 30/18109; B62D 33/06; B60T 2201/022; B60T 2210/10; B60T 2210/32; B60T 2250/04; B60W 2300/145; B60W 2554/80; B60W 2710/18; B60W 2710/30

(57) ABSTRACT

An autonomous vehicle selectively couplable to a trailer includes a cabin, at least one sensor coupled with the cabin and configured to capture signals of an environment in which the autonomous vehicle is operating, a secondary braking system operably coupled to the at least one sensor and supplemental to a primary braking system of the autonomous vehicle, and an autonomy computing system. The secondary braking system includes one or more movable flaps disposed on the cabin positionable between a first, undeployed position and a second, deployed position, where the one or more movable flaps engage air surrounding the autonomous vehicle to increase drag of the autonomous vehicle and decelerate the autonomous vehicle. The autonomy computing system is housed in the cabin and is programmed to operate the one or more movable flaps based on signals received from the at least one sensor.

### TECHNICAL FIELD

The field of the disclosure relates generally to autonomous vehicles and, more specifically, to braking systems and methods for autonomous vehicles.

### BACKGROUND OF THE INVENTION

Tractor trailers are generally very heavy and require far greater distance to stop when compared to typical passenger vehicles. Consequently, braking of tractor trailers causes increased wear on brakes. Under certain circumstances, it may be difficult for the typical braking system of the tractor trailer to stop the tractor trailer in time. Accordingly, there is a need of an improved braking system for tractor trailers.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In accordance with an aspect of the disclosure, an autonomous vehicle selectively couplable to a trailer includes a cabin, at least one sensor coupled with the cabin and configured to capture signals of an environment in which the autonomous vehicle is operating, a secondary braking system operably coupled to the at least one sensor and supplementary to a primary braking system of the autonomous vehicle, and an autonomy computing system housed in the cabin. The secondary braking system is operably coupled to the at least one sensor and is supplemental to a primary braking system of the autonomous vehicle. The secondary braking system includes one or more movable flaps disposed on the cabin. The one or more movable flaps are positionable between a first, undeployed position and a second, deployed position, wherein the one or more movable flaps are configured to engage air surrounding the autonomous vehicle to increase drag of the autonomous vehicle and decelerate the autonomous vehicle. The autonomy computing system includes at least one processor in communication with at least one memory device. The processor is programmed to operate the one or more movable flaps based on signals received from the at least one sensor.

In accordance with another aspect of the disclosure, a method for supplementally braking an autonomous vehicle includes installing a secondary braking system, supplemental to a primary braking system of the autonomous vehicle. The secondary braking system includes one or more movable flaps disposed on a cabin of the autonomous vehicle, the one or more movable flaps positionable between a first, undeployed position and a second, deployed position, where the one or more movable flaps engage air surrounding the autonomous vehicle to increase drag to the autonomous vehicle and decelerate the autonomous vehicle. The method includes operating, via an autonomy computing system of the autonomous vehicle, the one or more movable flaps, based on signals received from at least one sensor of the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a perspective view of an example autonomous vehicle in accordance with the disclosure;

FIG. 2 is an illustration of an autonomous vehicle operating on a roadway;

FIG. 3 is a block diagram of the autonomous vehicle shown in FIG. 1;

FIG. 4 is an elevation view of the autonomous vehicle of FIG. 1 illustrating movable flaps deployed to perform braking of the autonomous vehicle;

FIG. 5 is an elevation view of the autonomous vehicle of FIG. 1 coupled to a trailer;

FIG. 6 is a plan view of the autonomous vehicle and trailer of FIG. 5;

FIG. 7A is an elevation view of another embodiment of an autonomous vehicle in accordance with the disclosure;

FIG. 7B is a plan view of the autonomous vehicle of FIG. 7A, illustrating movable flaps deployed to perform braking of the autonomous vehicle;

FIG. 7C is a front view of the autonomous vehicle of FIG. 7A, illustrating the movable flaps deployed to perform braking of the autonomous vehicle;

FIG. 8 is an elevation view of the autonomous vehicle of FIG. 7A, illustrating a cabin having an aerodynamic shape of the autonomous vehicle in a deployed position;

FIG. 9 is an elevation view of one more embodiment of an autonomous vehicle in accordance with the disclosure, illustrating parachutes deployed to perform braking of the autonomous vehicle;

FIG. 10 is a plan view of the autonomous vehicle of FIG. 9;

FIG. 11 is a perspective view of a fifth-wheel hitch of the autonomous vehicle of FIG. 9;

FIG. 12 is a perspective view of the fifth-wheel hitch of FIG. 11 shown coupled to the autonomous vehicle of FIG. 9;

FIG. 13 is an elevation view of the autonomous vehicle of FIG. 9 shown decoupled from the trailer;

FIG. 14 is an elevation view of one more embodiment of an autonomous vehicle in accordance with the disclosure, illustrating thrusters deployed to perform braking of the autonomous vehicle;

FIG. 15 is a plan view of the autonomous vehicle of FIG. 14;

FIG. 16A is a flow diagram of a method of braking for an autonomous vehicle in accordance with the disclosure;

FIG. 16B is a continuation of the flow diagram of FIG. 16A; and

FIG. 17 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The disclosure is directed to systems and methods for braking for autonomous vehicles, although it is envisioned that the systems and methods described herein may be used for any vehicle, including autonomous and non-autonomous vehicles without departing from the scope of the disclosure. The systems and methods described herein may be applied in emergency and/or non-emergency situations to brake the autonomous vehicle to avoid collisions and/or mitigate damages in collisions. In embodiments, the systems and methods described herein may be applied as secondary and/or supplemental braking systems and methods that may be applied during normal, non-emergency situations to minimize or otherwise reduce wear and tear on the autonomous vehicle's braking system. The autonomy computing system described herein detects or otherwise monitors conditions on the road ahead of the autonomous vehicle as the autonomous vehicle is moving among various other vehicles or objects on the roadway. Given the autonomous vehicles current velocity and momentum, a normal stopping distance is known, or computable, for the autonomous vehicle. The autonomy computing system may determine if one or more secondary braking systems and/or methods may be utilized and/or an amount of each of the one or more secondary braking systems and/or methods to employ. In the event of a rapid unforeseen appearance of deceleration of an object in the roadway, the velocity of the autonomous vehicle and the computed normal stopping distance indicates a potential collision between the autonomous vehicle and the object is imminent. A secondary braking module in communication with the autonomy computing system computes a braking distance that suggests the collision can be avoided if secondary braking is employed. It is envisioned that the secondary braking module may (a) deploy one or more air brakes or drag inducing surfaces operably coupled to the autonomous vehicle, (b) deploy one or more parachutes operably coupled to the autonomous vehicle, and/or (c) actuate one or more rocket motors/engines or thrusters operably coupled to the autonomous vehicle.

Tractor trailers are generally very heavy, requiring far greater distance to stop and causing increased wear and tear on the braking system when compared to typical passenger vehicles. Under certain circumstances, the typical braking system of the tractor trailer may not be able to stop the tractor trailer in time to avoid a collision. The secondary braking systems and methods described herein provide supplementary braking to the primary braking systems of a vehicle, enabling the vehicle to stop in a shorter distance when compared to utilizing the primary braking system alone. The secondary braking system and methods described herein also enable the vehicle to rely less on the primary braking system during normal, non-emergency braking maneuvers, reducing wear and tear on the primary braking system. As will be described herein, the secondary braking system may employ one or more movable air flaps, one or more parachutes, one or more rockets and/or thrusters, and combinations thereof. The secondary braking systems engage or otherwise utilize air surrounding the vehicle to increase the drag of the vehicle traveling through the air or provide increased resistance to the vehicle traveling through the air. Autonomous vehicles do not require a human to operate, enabling the cabin to be modified to remove the windshield, side view mirrors, and reshape a profile of the cabin to be more aerodynamic and include more surface area upon which secondary braking systems can be disposed when compared to vehicles requiring a human to operate.

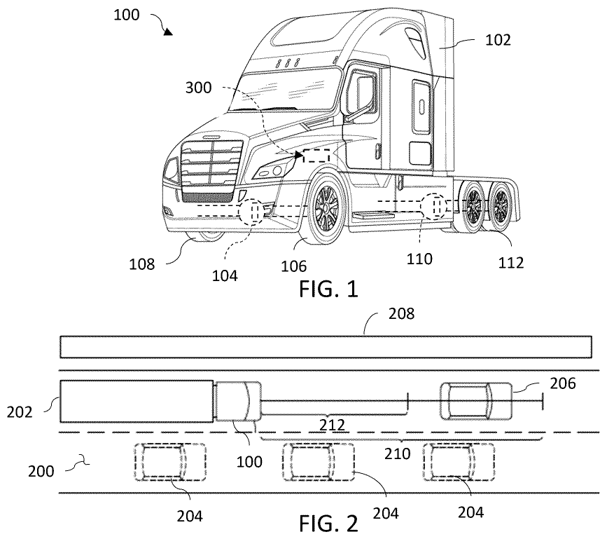

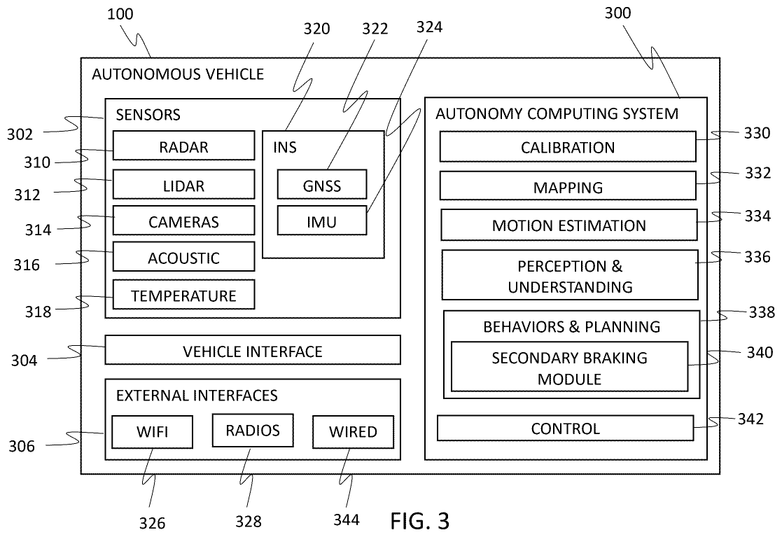

Turning now to the drawings, FIG. 1 illustrates an autonomous vehicle 100 including a cabin 102 that may be supported, and steered in, the required direction by a front or first axle 104 having front wheels 106 and 108, and a second or rear axle 110 having rear wheels 112 that are partially shown in FIG. 1. The cabin 102 may be an uncrewed cabin or a crewed cabin. in some embodiments, the rear wheels 112 of the autonomous vehicle 100 may be operably coupled to any number of axles without departing from the scope of the disclosure. In one non-limiting embodiment, the rear wheels 112 are operably coupled to two axles, where the rear axle 110 is defined generally as a midpoint between each of the two axles. The front wheels 106, 108 are positioned by a steering system that includes a steering wheel and a steering column (not shown). The steering wheel and the steering column may be located in the interior of the cabin 102. It is envisioned that the autonomous vehicle 100 may be an autonomous vehicle that may be operated by an autonomy computing system 300 (see FIG. 3, described later) based on data collected by a sensor network including one or more sensors. As can be appreciated, the steering wheel and the steering column, and all or parts of the cabin 102, may be omitted in an autonomous vehicle.

FIG. 2 is an illustration of the autonomous vehicle 100 shown in FIG. 1 operating on a roadway 200. The autonomous vehicle 100 is illustrated operating on the roadway 200, pulling a trailer 202 and moving among various other vehicles or objects on the roadway 200. In particular, various other vehicles 204 occupy the right lane and the autonomous vehicle 100 is approaching an object 206 on the roadway 200. The object 206 may be another vehicle moving in the same direction as the autonomous vehicle 100, a structure, debris, a person, wildlife, or any other object with which a collision should be avoided under normal circumstances. Additionally, the roadway 200 is bounded on the left side by a fixed barrier structure 208.

Given the autonomous vehicle's 100 current velocity and momentum, a normal stopping distance 210 is known, or computable, for the autonomous vehicle 100 when a primary braking system of the autonomous vehicle 100 is used. In the illustration of FIG. 2, in the event of a rapid unforeseen appearance or deceleration of the object 206, the velocity of the autonomous vehicle 100 and computed normal stopping distance 210, indicates a potential collision between the autonomous vehicle 100 and the object 206 is imminent, where the normal stopping distance 210 does not provide enough distance for the autonomous vehicle 100 to avoid collision with the object 206. The disclosed secondary braking system computes a secondary braking distance 212 to avoid the potential collision if secondary braking is employed. For example, the disclosed secondary braking systems may (a) deploy one or more air brakes or drag inducing surfaces operably coupled to the autonomous vehicle 100, (b), deploy one or more parachutes operably coupled to the autonomous vehicle 100, and/or (c) actuate one or more rocket engines or thrusters operably coupled to the autonomous vehicle. Although generally described with reference to a potential collision between the autonomous vehicle 100 and the object 206, the secondary braking system may be employed during normal, non-emergency braking situations. The secondary braking system may be employed to reduce the load on the primary braking system of the autonomous vehicle 100, reducing or otherwise minimizing wear and tear on the primary braking system during normal operating conditions.

With reference to FIG. 3, a block diagram of the autonomous vehicle 100 is illustrated. In the example embodiments, the autonomous vehicle 100 includes the autonomy computing system 300, sensors 302, a vehicle interface 304, and external interfaces 306. In the example embodiment, the sensors 302 may include various sensors such as, for example, radio detection and ranging (RADAR) sensors 310, light detection and ranging (LiDAR) sensors 312, cameras 314, acoustic sensors 316, temperature sensors 318, or an inertial navigation system (INS) 320, which may include one or more global navigation satellite system (GNSS) receivers 322 and one or more inertial measurement units (IMU) 324. Other sensors 302 not shown in FIG. 3 may include, for example, acoustic (e.g., ultrasound), internal vehicle sensors, meteorological sensors, or other types of sensors. The sensors 302 generate respective output signals based on detected physical conditions of the autonomous vehicle 100 and its proximity. As described in further detail below, these signals may be used by the autonomy computing system 300 to determine how to control operation of the autonomous vehicle 100.

The cameras 314 are configured to capture images of the environment surrounding the autonomous vehicle 100 in any aspect or field of view (FOV). The FOV may have any angle or aspect such that images of the areas in front of, to the side of, behind, above, or below the autonomous vehicle 100 may be captured. In some embodiments, the FOV may be limited to particular areas around the autonomous vehicle 100 (e.g., forward of the autonomous vehicle 100, to the sides of the autonomous vehicle 100, etc.) or may surround 360 degrees of the autonomous vehicle 100. In some embodiments, the autonomous vehicle 100 includes multiple cameras 314, and the images from each of the multiple cameras 314 may be stitched or combined to generate a visual representation of the multiple cameras'FOVs, which may be used to, for example, generate a bird's eye view of the environment surrounding the autonomous vehicle 100. In some embodiments, the image data generated by the cameras 314 may be sent to the autonomy computing system 300 or other aspects of the autonomous vehicle 100, and this image data may include the autonomous vehicle 100 or a generated representation of the autonomous vehicle 100. In some embodiments, one or more systems or components of the autonomy computing system 300 may overlay labels to the features depicted in the image data, such as on a raster layer or other semantic layer of a high-definition (HD) map.

The LiDAR sensors 312 generally include a laser generator and a detector that send and receive a LiDAR signal such that LiDAR point clouds (or “LiDAR images”) of the areas ahead of, to the side of, behind, above, or below the autonomous vehicle 100 may be captured and represented in the LiDAR point clouds. The radar sensors 310 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from the cameras 314, the radar sensors 310, or the LiDAR sensors 312 may be fused or used in combination to determine conditions (e.g., locations of other objects) around the autonomous vehicle 100.

With continued reference to FIG. 3, the GNSS receiver 322 is positioned on the autonomous vehicle 100 and may be configured to determine a location of the autonomous vehicle 100, which may be embodied as GNSS data, as described herein. The GNSS receiver 322 may be configured to receive one or more signals from a global navigation satellite system (e.g., Global Positioning System (GPS) constellation) to localize the autonomous vehicle 100 via geolocation. In some embodiments, the GNSS receiver 322 may provide an input to or be configured to interact with, update, or otherwise utilize one or more digital maps, such as an HD map (e.g., in a raster layer or other semantic map). In some embodiments, the GNSS receiver 322 may provide direct velocity measurement via inspection of the Doppler effect on the signal carrier wave. It is envisioned that multiple GNSS receivers 322 may also provide direct measurements of the orientation of the autonomous vehicle 100. For example, with two GNSS receivers 322, two attitude angles (e.g., roll and yaw) may be measured or determined. In some embodiments, the autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about the autonomous vehicle 100 and its environment.

The IMU 324 is a micro-electrical-mechanical (MEMS) device that measures and reports one or more features regarding the motion of the autonomous vehicle 100, although other implementations are contemplated, such as mechanical, fiber-optic gyro (FOG), or FOG-on-chip (SiFOG) devices. The IMU 324 may measure an acceleration, an angular rate, and/or an orientation of the autonomous vehicle 100 or one or more of its individual components using a combination of accelerometers, gyroscopes, or magnetometers. The IMU 324 may detect linear acceleration using one or more accelerometers and rotational rate using one or more gyroscopes and attitude information from one or more magnetometers. In some embodiments, the IMU 324 may be communicatively coupled to one or more other systems, for example, the GNSS receiver 322 and may provide input to and receive output from the GNSS receiver 322 such that the autonomy computing system 300 is able to determine the motive characteristics (e.g., acceleration, speed/direction, orientation/attitude, etc.) of the autonomous vehicle 100.

In the example embodiment, the autonomy computing system 300 employs the vehicle interface 304 to send commands to the various aspects of the autonomous vehicle 100 that actually control the motion of the autonomous vehicle 100 (e.g., engine, throttle, steering wheel, brakes, etc.) and to receive input data from one or more of the sensors 302 (e.g., internal sensors). The external interfaces 306 are configured to enable the autonomous vehicle 100 to communicate with an external network via, for example, a wired connection 344 (e.g., Ethernet, USB, Serial, etc.) or wireless connection, such as Wi-Fi 326 or other radios 328. In embodiments including a wireless connection, the connection may be a wireless communication signal (e.g., Wi-Fi, cellular, LTE, 5g, Bluetooth, etc.).

With continued reference to FIG. 3, in some embodiments, the external interfaces 306 may be configured to communicate with an external network via the wired connection 344, such as, for example, during testing of the autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by the autonomous vehicle 100 to navigate or otherwise operate, either autonomously or semi-autonomously. The digital files, executable programs, and other computer readable code may be stored locally or remotely and may be routinely updated (e.g., automatically or manually) via the external interfaces 306 or updated on demand. In some embodiments, the autonomous vehicle 100 may deploy with all of the data it needs to complete a mission (e.g., perception, localization, and mission planning) and may not utilize a wireless connection or other connection while underway.

In the example embodiment, the autonomy computing system 300 is implemented by one or more processors and memory devices of the autonomous vehicle 100. Autonomy computing system 300 includes modules, which may be hardware components (e.g., processors or other circuits) or software components (e.g., computer applications or processes executable by the autonomy computing system 300), configured to generate outputs, such as control signals, based on inputs received from, for example, the sensors 302. These modules may include, for example, a calibration module 330, a mapping module 332, a motion estimation module 334, a perception and understanding module 336, a behaviors and planning module 338, a secondary braking module 340, and a control module or controller 342. The secondary braking module 340, for example, may be embodied within another module, such as the behaviors and planning module 338, or separately. These modules may be implemented in dedicated hardware such as, for example, an application specific integrated circuit (ASIC), a field programmable gate array (FPGA), or a microprocessor, or implemented as executable software modules, or firmware, written to memory and executed on one or more processors onboard the autonomous vehicle 100.

It is envisioned that the autonomy computing system 300 of the autonomous vehicle 100 may be completely autonomous (fully autonomous) or semi-autonomous. In one example, the autonomy computing system 300 may operate under Level 5 autonomy (e.g., for example, full driving automation), Level 4 autonomy (e.g., for example, high driving automation), or Level 3 autonomy (e.g., for example, conditional driving automation). As used herein the term “autonomous” includes both fully autonomous and semi-autonomous.

The autonomy computing system 300 detect conditions on the road ahead of the autonomous vehicle 100, including the existence of a potential collision. Upon determining a potential collision is imminent, the autonomy computing system 300 engages the secondary braking module 340 to determine whether a mode of secondary braking should be applied to avoid or mitigate the potential collision. In embodiments, the autonomy computing system 300 engages the secondary braking module 340 upon detection of a situation where braking or otherwise slowing the autonomous vehicle 100 down is necessary. The secondary braking module 340 determines whether to apply one or more secondary braking modalities and/or an amount of the one or more secondary braking modalities to apply.

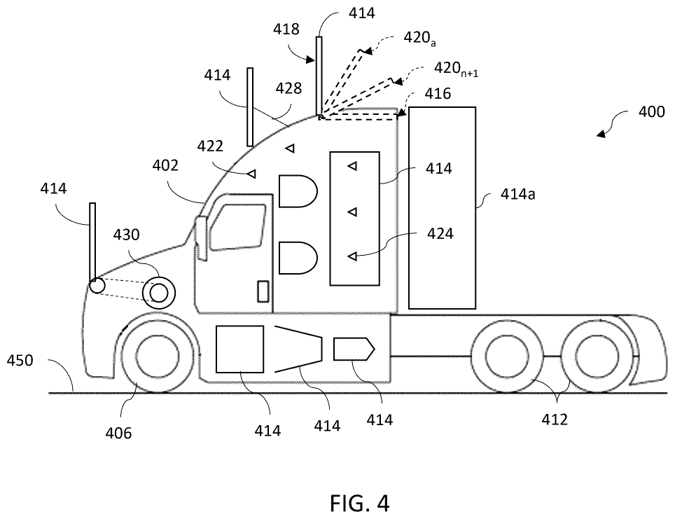

Turning to FIGS. 4-6, an example embodiment of an autonomous vehicle 400 coupled to a trailer 440 on a roadway 450 is illustrated. The autonomous vehicle 400 is substantially similar to the autonomous vehicle 100, and therefore, only the differences therebetween will be described in detail herein in the interest of brevity. The autonomous vehicle 400 includes one or more movable flaps or drag inducing surfaces 414 operably coupled to the cabin 402. The one or more movable flaps 414 are positionable between a first, undeployed position 416, a second, fully deployed position 418, and one or more intermediate positions 420ₐ-420ₙ₊₁. It is envisioned that the one or more movable flaps 414 may be operably coupled to the cabin 402 in any manner, enabling the one or more movable flaps 414 to rotate relative to the cabin 402, extend at any angle relative to the cabin 402, and/or combinations thereof. In one non-limiting embodiment, the one or more movable flaps 414 are hingedly coupled to the cabin 402. In some embodiments, all of the one or more movable flaps 414 may be deployed simultaneously, defining a generally pine-cone or pine-like shaped profile (e.g., when viewed from the front of the autonomous vehicle 400) having the one or more flaps extending laterally outward from each surface of the cabin 402. In one non-limiting embodiment, all or a portion of the one or more movable flaps 414 disposed on any surface (e.g., a top surface, a side surface, a front surface, etc.) extend upward and away from the cabin 402.

In one non-limiting embodiment, the one or more movable flaps 414 are dynamic cabin extenders 414a operably coupled to the cabin 402. In this manner, the secondary braking module 340 may cause the dynamic cabin extenders 414a to deploy laterally outward from the cabin 402 (see FIG. 6) and effectuate secondary braking on the autonomous vehicle 400. In other embodiments, upon a determination that a potential collision is imminent, the secondary braking module 340 causes the dynamic cabin extenders 414a to deploy laterally outward from the cabin 402.

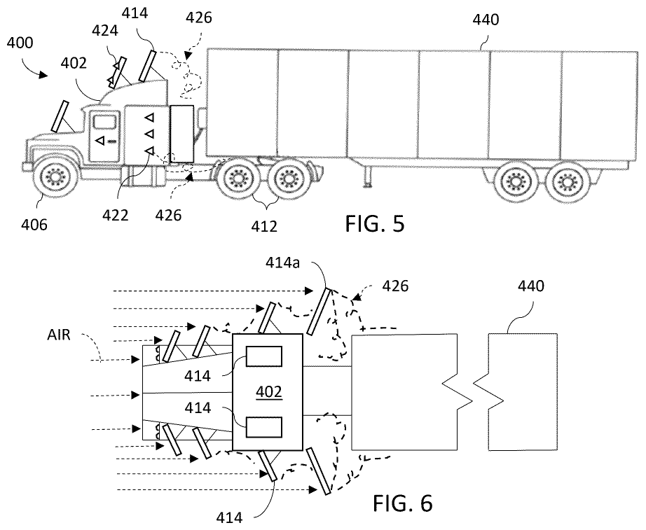

The one or more movable flaps 414 may include any profile, which may vary depending upon the location of the one or more movable flaps 414 on the cabin 402. Movable flaps of the one of more movable flaps 414 disposed on a top portion or roof 403 of the cabin 402 may be larger or extend further away from the cabin 402 than flaps of the one or more movable flaps 414 disposed on sides of the cabin 402. In some embodiments, the autonomy computing system 300, using data received from the one or more sensors 302, identifies vehicles and other objects on the roadway and control deployment of the one or more movable flaps 414 to mitigate the risk of or otherwise avoid collisions between the one or more movable flaps 414 and the identified vehicles and other object. As can be appreciated, aerodynamic effects of the cabin 414 may direct the flow of air to certain locations on the cabin 414, may increase and/or decrease a pressure of the air flowing over the cabin 414, may increase and/or decrease a velocity of the air flowing over the cabin 414, etc. In this manner, the shape or profile of each flap of the one or more movable flaps 414 may be selected or otherwise determined based on the location of the movable flap 414 on the cabin 402. In embodiments, flaps of the one or more movable flaps 414 or other features 422 disposed or otherwise formed on the cabin 402 may direct the flow of air towards other flaps of the one or more movable flaps 414 or certain features of the autonomous vehicle 400, such as the front wheels 406 and 408 and/or the rear wheels 412, the void between the cabin 402 and the trailer 440, and/or other locations having high turbulence or drag (See FIGS. 5 and 6).

The one or more movable flaps 414 may be positioned or may include one or more features 424 that cause air flowing over the one or more movable flaps 414 to engage or otherwise interact with the trailer 440. As can be appreciated, the position of the one or more movable flaps 414 and/or the one or more features 424 disturb air flowing over the one or more movable flaps 414 and generate or otherwise cause vortexes and/or eddies 426 to form (See FIGS. 5 and 6). The one or more features 424 may be protrusions, dimples, cut-outs, supplementary flaps, linear and non-linear profiles of the perimeter of the one or more movable flaps 414 (e.g., curvilinear profile, saw-tooth profile, etc.) The vortexes and/or eddies 426 engage or otherwise interact with portions of the trailer 440 to increase an amount of drag generated by air flowing over trailer 440. The autonomy computing system 300 may identify or otherwise take into account a type of trailer 440 that is coupled to the autonomous vehicle 400 to determine or otherwise compute an optimum position of the one or more movable flaps 414 to direct the flow of air and/or vortexes 426 to one or more identified positions on the trailer 440 that would result in a desired or a maximum amount of drag at a given velocity and atmospheric conditions. As can be appreciated, the number of movable flaps 414, the geometry of the one or more movable flaps 414, and the one or more features 424 of the one or more movable flaps 414 may be taken into account when determining the optimal position of the one or movable flaps 414. In embodiments, the secondary braking module 340 may modulate or otherwise adjust a position of the one or more movable flaps 414 as the velocity of the autonomous vehicle 400 decreases to maintain or otherwise maximize the braking effect of the one or more movable flaps 414 in an emergency braking situation. In some embodiments, the secondary braking module 340 may modulate or otherwise adjust the position of the one or more movable flaps 414 as the velocity of the autonomous vehicle 400 decreases to maintain or otherwise cause a desired braking effect of the one or movable flaps 414 during normal braking situations.

When in motion, the air flowing over the autonomous vehicle 400 and the trailer 420 coupled to the autonomous vehicle 400 act as a system, where air flowing over the autonomous vehicle 400 affects the flow of air over trailer 440 and vice versa. In this manner, although generally described as directing the flow of air towards other flaps of the one or more movable flaps 414 or the trailer 440, it is envisioned that the aerodynamic effects of air flowing over the autonomous vehicle 400, and the trailer 440 coupled to the autonomous vehicle 400, may be considered when determining the positions of the one or more movable flaps 414 on the cabin 402, the shapes of the one or more movable flaps 414, the deployed position of the one or more movable flaps 414, the features 422, 424 disposed or formed on the one or more movable flaps 414 and/or the cabin 402, etc., and combinations thereof.

The autonomous vehicle 400 includes one or more actuators 428 operably coupled to the cabin 402 and one or more movable flaps 414. The one or more actuators 422 may be interposed between the cabin 402 and the one or movable flaps 414 to selectively move the one or more movable flaps 414 between the first position 416, the second position 418, and the one or more intermedial positions 420ₐ-420ₙ₊₁. It is envisioned that the one or more actuators 428 may be a pneumatic actuator, a hydraulic actuator, a biasing element, a pyrotechnic device, a propellant, an airbag, etc., and combinations thereof. In this manner, the one or more actuators 428 may be single use (e.g., deployable only) or may be reusable (e.g., deployable and retractable).

In embodiments, the one or more movable flaps 414 may be operably coupled to one or more drive motors 430 (e.g., stand-alone electric motors, electric motors driving the wheels of the autonomous vehicle 400, etc.), combustion engines (e.g., stand-alone combustion engines, combustion engines driving the wheels of the autonomous vehicle), etc., and/or combinations thereof. It is envisioned that the one or more movable flaps 414 may be operably coupled to the one or more drive motors 430 using mechanical gearing, magnetic gearing, shafts, chains, belts, etc., and/or combinations thereof. As can be appreciated, the one or more movable flaps 414 may be actuated individually, may be actuated in unison, or may be actuated in groups. In this manner, the secondary braking module 340 may determine which movable flaps 414 and how many movable flaps 414 to deploy.

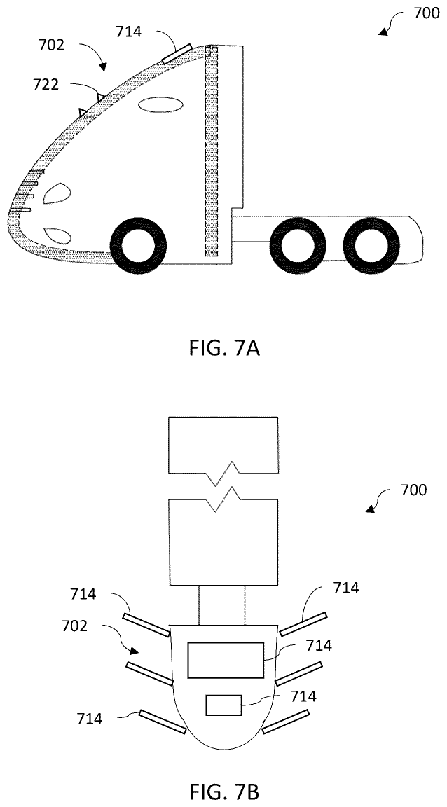

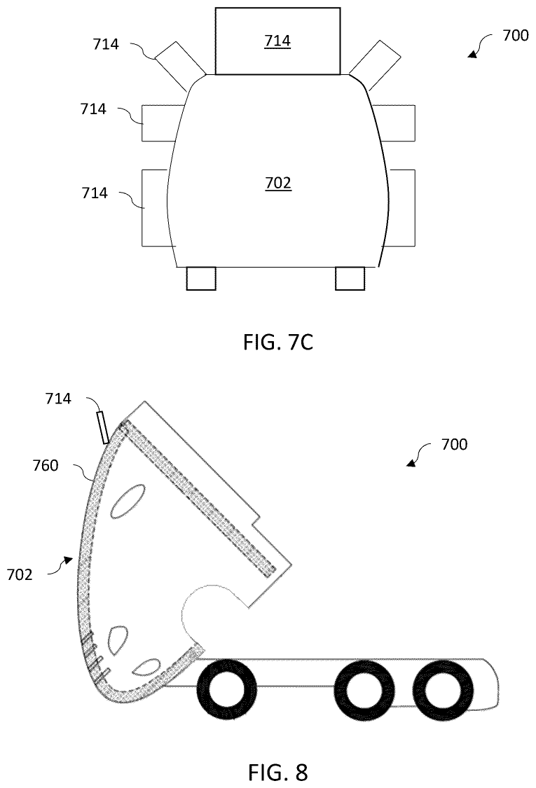

With additional reference to FIGS. 7A-8, it is envisioned that a cabin 702 of an autonomous vehicle 700 may be an uncrewed cabin omitting various fixtures, systems, and equipment for use by a human driver. With the removal of the fixtures, systems, and equipment from the uncrewed cabin 702 and associated uncrewed cabin space, the uncrewed cabin 702 and the associated uncrewed cabin space may be redesigned or repurposed to improve the performance of the autonomous vehicle 700 by including an aerodynamic shape. By way of example, the modified uncrewed cabin 702 may improve aerodynamic properties of the autonomous vehicle 700 and provide additional space for the placement of movable flaps 714 or other features 722 disposed on the uncrewed cabin 702, further increasing the effectiveness of a secondary braking system employing movable flaps 714. In some embodiments, a windshield may be removed. Additionally, side view mirrors may also be removed. Alternatively, the side view mirrors may be designed as fully retractable into a body of the uncrewed cabin 702 or a body of the autonomous vehicle 700 to create a smooth outer surface of the body of the uncrewed cabin 702 or the body of the autonomous vehicle 700. Without the need for a windshield, side view mirrors, and other fixtures, systems, and equipment for use by a human driver, one or movable flaps 714 may cover or otherwise be disposed on all or a significant portion of the uncrewed cabin 702 (see FIGS. 7B and 7C). As described herein, all or generally all of the one or more movable flaps 714 may be deployed simultaneously to define a pine cone or pine-like shaped profile, with the one or more movable flaps 714 extending laterally outward from the uncrewed cabin 702.

Since the fixtures, systems, and equipment from the uncrewed cabin 702 are removed, the uncrewed cabin space or uncrewed cabin volume is substantially reduced, for example, by about at least 50 percent in comparison with the uncrewed cabin space or uncrewed cabin volume of a non-autonomous vehicle. Accordingly, in some embodiments, the uncrewed cabin 702 may include an airfoil or may be in the shape of an airfoil or any aerodynamic shape. It is contemplated that the uncrewed cabin 702 may be moved or extended downward, for example, in the space that is previously occupied by the windshield and an engine housing. The uncrewed cabin 702 that is moved or extended further downward may improve aerodynamic properties of the autonomous vehicle 700 and be used to induce drag during secondary braking and/or an emergency braking event. The uncrewed cabin 702 may be manipulated or otherwise oriented in a position that induces additional drag on the autonomous vehicle 700 when the autonomy computing system 300 determines that a potential collision is imminent and/or secondary braking should be applied. In one non-limiting embodiment, the uncrewed cabin 702 may be transitioned from a first, undeployed position for driving (See FIG. 7A) to a second, deployed position (See FIG. 8). As can be appreciated, during normal driving conditions (e.g., travelling along the roadway 450), maximum fuel efficiency and therefore, minimal drag is desired. When in the first, undeployed position, the uncrewed cabin 702 defines a first frontal area defining a first drag coefficient. When in the second, deployed position, the uncrewed cabin 702 is rotated or otherwise manipulated to an orientation where the uncrewed cabin 702 defines a second frontal area and/or a second drag coefficient. To assist with secondary braking, at least one of the second frontal area or the second drag coefficient is greater than the first frontal area and/or the first drag coefficient. The autonomy computing system 300 may deploy the uncrewed cabin 702 as secondary braking by itself or may deploy a combination of the uncrewed cabin 702 and one or more movable flaps 414 as secondary braking without departing from the scope of the disclosure.

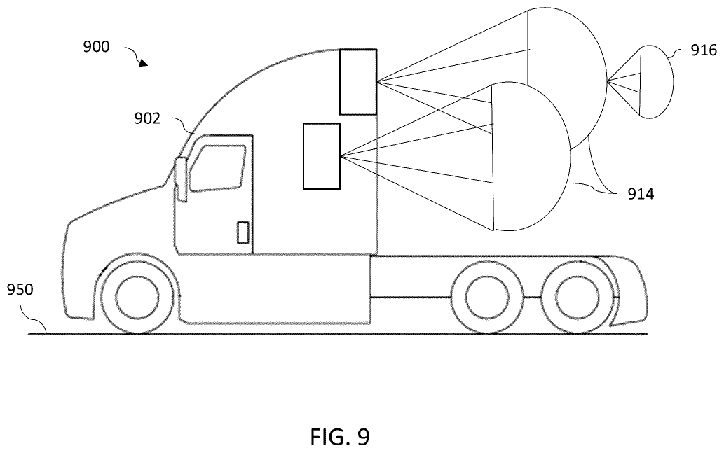

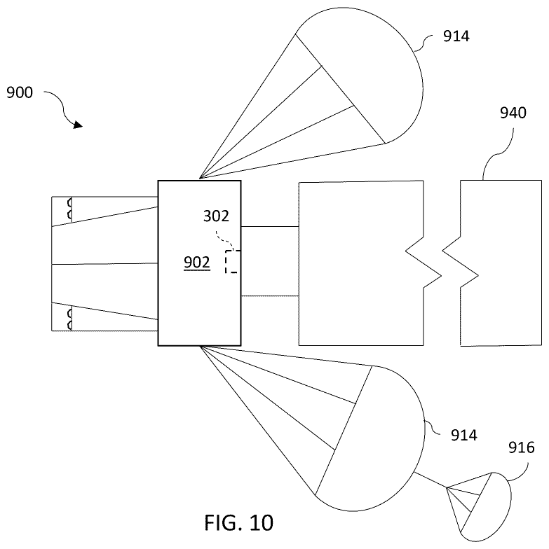

With reference to FIGS. 9 and 10, another embodiment of an autonomous vehicle 900 coupled to a trailer 940 (FIG. 10) on a roadway 950 is illustrated. The autonomous vehicle 900 is substantially similar to the autonomous vehicle 100, and therefore only the differences therebetween will be described in detail herein in the interest of brevity. The autonomous vehicle 900 includes one or more parachutes 914 operably coupled to the autonomous vehicle 900. In one non-limiting embodiment, the one or more parachutes 914 are operably coupled to the cabin 902 of the autonomous vehicle. It is envisioned that the one or more parachutes 914 may be any parachute, and in embodiments, may be a drogue chute without departing from the scope of the disclosure. The one or more parachutes 914 are deployable upon a determination by the autonomy computing system 300 that secondary braking should be applied and/or a potential collision is imminent. It is envisioned that the one or more parachutes may define any profile, may include any surface area, and may include any number and size of vents depending upon the design needs of the autonomous vehicle 900. In one non-limiting embodiment, one or more of the parachutes 914 may include a pilot chute 916 for assisting with extracting the parachute 914 and/or delaying deployment of the parachute 914. The autonomous vehicle 900 may employ any number of parachutes 914 which may be disposed at any location on the autonomous vehicle 900.

As can be appreciated, the proximity of the trailer 940 to the cabin 902 may interfere with or otherwise affect deployment of the one or more parachutes 914. To mitigate interference with the trailer 940, the one or more parachutes 914 may be disposed about an outer perimeter and/or adjacent to the outer edges of the cabin 902. Placement of the one or more parachutes 914 about the outer perimeter of the cabin 902 causes the one or more parachutes 914 to deploy besides or otherwise laterally outward from the trailer 940. Pilot chutes 916 may be coupled to the one or more parachutes 914 to delay deployment of the parachutes 914 until the one or more parachutes 914 clear or otherwise extend past the void between the cabin 902 and the trailer 940. In embodiments, the autonomy computing system 300 may control a rate at which the one or more parachutes 914 are deployed or control an amount of deployment of the one or more parachutes 914 to mitigate or otherwise avoid interference with the trailer 940. In this manner, the autonomy computing system 300 may monitor data obtained by the perception and understanding module 336, in cooperation with one or more of the sensors 302, to determine a position of deployed or partially deployed parachutes of the one or more parachutes 914 relative to the trailer 940. The autonomy computing system 300 controls or otherwise meters an amount of deployment of each parachute of the one or more parachutes 914 to avoid interference with the trailer 940. The autonomy computing system 300 may partially deploy the one or more parachutes 914 and monitor one or more of the sensors 302 to determine a position of the one or more parachutes 914 relative to the trailer 940. When the autonomy computing system 300 identifies or otherwise determines that there is no contact and/or interference between the one or more parachutes 914 and the trailer 940, the autonomy computing system 300 releases or otherwise deploys the remainder of the one or more parachutes 940. As can be appreciated, controlling the rate at which, or the amount of, the one or more parachutes 914 are deployed enhances the ability of the one or more parachutes 914 to slow the autonomous vehicle 900 down as quickly as possible as compared to if the one or more parachutes 914 interfered with the trailer 940. It is contemplated that controlling the rate of deployment of the one or more parachutes 914 using the autonomy computing system 300 may obviate the need to employ pilot chutes 916 or reduce a number of pilot chutes 916 needed to perform secondary braking and/or the emergency braking maneuver.

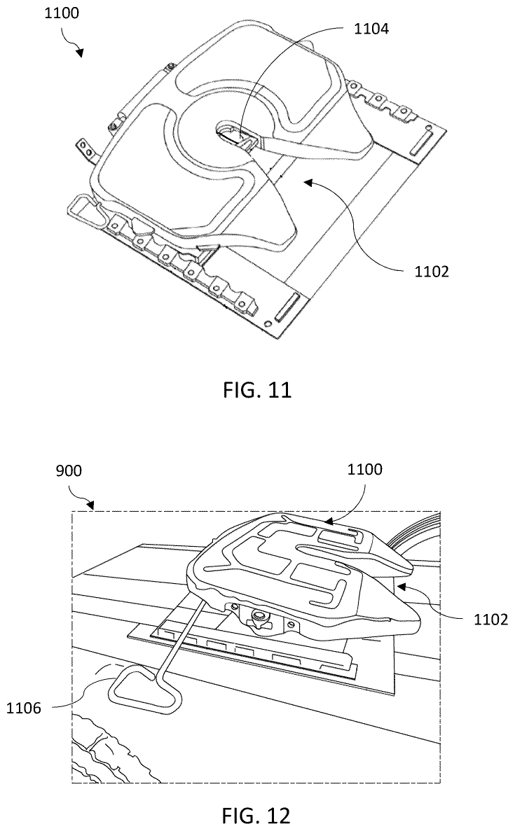

With additional reference to FIGS. 11-13, upon detection of a potential collision, the autonomy computing system 300 may release or otherwise detach the trailer 940 from the autonomous vehicle 900. The autonomous vehicle 900 includes a fifth-wheel hitch 1100 that is operably coupled to the autonomous vehicle 900 at a position that is generally above the rear axle 910 (e.g., in a direction extending from the roadway 950. The fifth-wheel hitch 1100 defines a throat 1102 having a pair of locking jaws 1104 that selectively receive and engage a coupling unit or trailer kingpin 942 of the trailer 940 and selectively couple the trailer 940 to the autonomous vehicle 900. It is envisioned that the pair of locking jaws 1104 may be manually operated or automatically operated via the autonomy computing system 300. When the autonomy computing system 300 determines that a potential collision is imminent, the autonomy computing system 300 instructs or otherwise autonomously control operation of the pair of locking jaws 1104 to release or decouple the trailer 940 from the fifth-wheel hitch 1100.

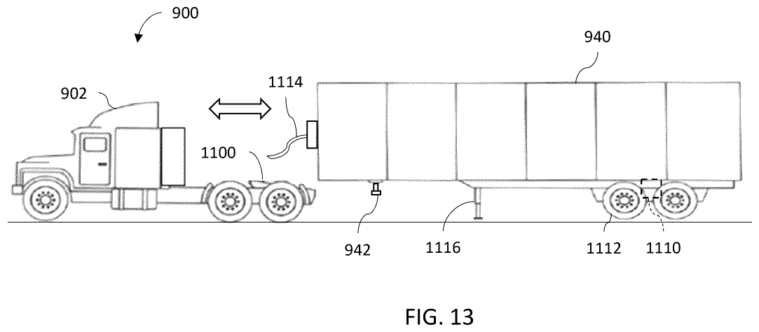

The autonomy computing system 300 may engage trailer brakes 1110 (e.g., a portion of the primary braking system of the autonomous vehicle 900) operably coupled to one or more trailer wheels 1112 supporting the trailer 940 on the roadway 950. Disengaging the trailer 940 from the fifth-wheel hitch 1100 causes the trailer 940 to separate from the autonomous vehicle 900, decoupling air hoses 1114 supplying compressed air to the trailer brakes 1110 (FIG. 13). As can be appreciated, the trailer brakes 1110 are configured to fail-closed (e.g., apply maximum braking force) when a source of compressed air is removed, causing the trailer 940 to rapidly decelerate. Movement of the autonomous vehicle, and therefore, the fifth-wheel hitch 1100, out from under the trailer 940 may damage or destroy air hoses 1114 that supply compressed air to the brakes of both the autonomous vehicle 900 and the trailer 940. However, the compressor and air tank (not shown) disposed on the autonomous vehicle 900 may allow the autonomous vehicle 900 to move a safe distance (e.g., 20 ft) from the trailer 940 before engaging the primary or secondary brakes of the autonomous vehicle 900. The delay between decoupling the trailer 940 and causing the trailer brakes 1110 to engage, mitigates the probability that the trailer 940 will impact or otherwise cause damage to the back of the cabin 902 when the autonomous vehicle 900 is slowed down. Additionally, engaging the trailer brakes 1110 once the trailer 940 is released or decoupled from the fifth-wheel hitch 1100 causes the trailer 940 to separate from the autonomous vehicle quickly, enabling the one or more parachutes 914 to quickly deploy and slow the autonomous vehicle without interference between the trailer 940 and the one or more parachutes 914.

In one non-limiting embodiment, the trailer 940 may include landing gear 1116 in communication with the autonomy computing system 300. The landing gear 1116 is operably coupled to the trailer 940 and is transitionable from a first, undeployed position and a second, deployed position, where the landing gear 1116 engages or otherwise contacts the roadway 950 and substantially maintains a vertical height of the trailer kingpin 942 relative to the roadway 950. Supporting the trailer 940 using the landing gear 1116 enables the trailer 940 to decouple from the autonomous vehicle 900 without dragging on or otherwise damaging the rear of the autonomous vehicle 900 as the trailer kingpin 942 and the front of the trailer 940 drop to the roadway 950.

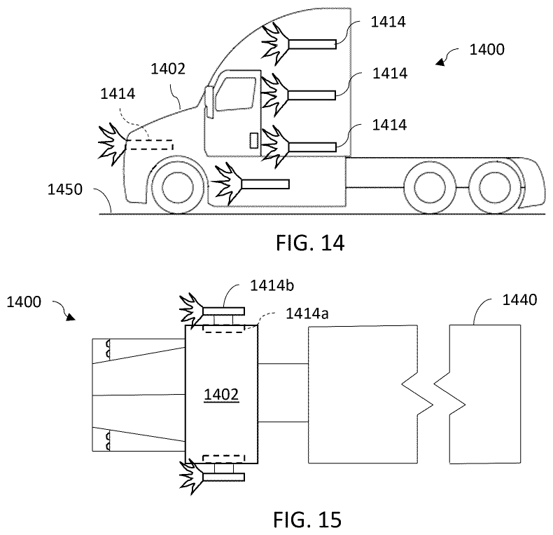

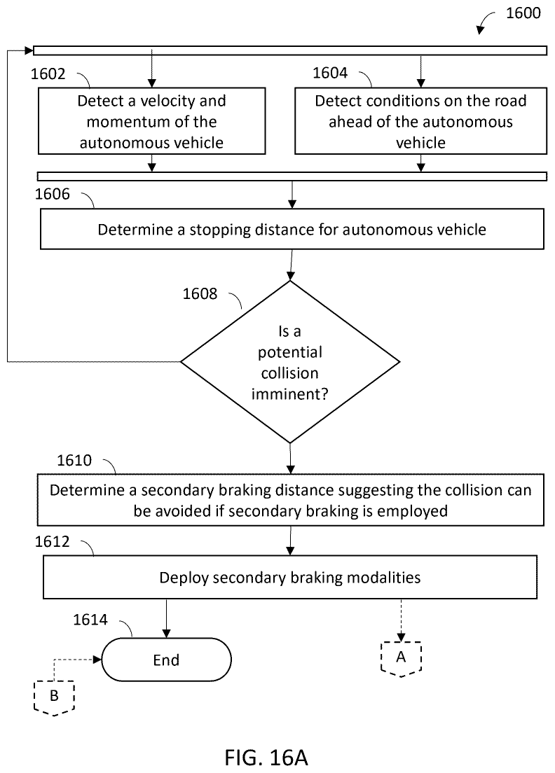

Turning to FIGS. 14 and 15, one more embodiment of an autonomous vehicle 1400 coupled to a trailer 1440 (FIG. 15) on a roadway 1450 is illustrated. The autonomous vehicle 1400 is substantially similar to the autonomous vehicle 100, and therefore, only the differences therebetween will be described in detail herein in the interest of brevity. In embodiments, one or more rocket engines or thrusters 1414 are operably coupled to the autonomous vehicle 1400. The one or more thrusters 1414 are forward facing and configured to provide thrust is directed against the autonomous vehicle 1400 (e.g., in the opposite direction of movement of the autonomous vehicle 1400 on the roadway 1450), thereby decelerating the autonomous vehicle 1400. The one or more thrusters 1414 are actuatable when the autonomy computing system 300 detects or otherwise determines that a potential collision is imminent and/or secondary braking should be applied. The thrust generated by the one or more thrusters 1414 acts against the ambient air and decelerates or otherwise rapidly slows movement of the autonomous vehicle 1400 along the roadway 1450.

As can be appreciated, the significant weight of the autonomous vehicle 1400 causes the autonomous vehicle to carry a large momentum, requiring significant thrust, and impulse, to counteract the momentum of the autonomous vehicle 1400 moving on the roadway 1450 and rapidly decelerate the autonomous vehicle 1400. For example, the momentum of a 35 megagram (Mg) autonomous vehicle 1400 travelling at approximately 30 meters per second (m/s) is 105 kNs. In one example, the one or more thrusters 1414 may be a 13 mm model rocket engine, producing a total impulse of approximately 2 Ns in about one second, requiring approximately 50,000 thrusters 1414. In another example, the one or more thrusters 1414 are a composite-propellant model rocket motor, producing a total impulse of approximately 136 Ns, requiring approximately 800 thrusters 1414. It is envisioned that the one or more thrusters 1414 may be a rocket motor having a level 2 certification, which in embodiments, may produce a total impulse of approximately 5 kNs, requiring approximately 26 thrusters 1414. Although generally described as using solid fuel or composite fuel, it is envisioned that the one or more thrusters 1414 may use liquid fuel, which may provide additional thrust and allow for more control compared to solid fuel rocket motors.

The autonomous vehicle 1400 may include any number of thrusters 1414 which may be disposed at any location on the autonomous vehicle 1400. One or more of the thrusters 1414 may be concealed within a portion of the cabin 1402 and remain concealed when the thruster 1414 is actuated (e.g., only a portion of the thruster 1414 is exposed). In embodiments, one or more of the thrusters 1414 may be selectively transitioned from a first, concealed or un-extended position 1414a, to a second, exposed or extended position 1414b where the one or more thrusters 1414 can be actuated (FIG. 15). The autonomous vehicle 1400 is not limited to using a single type of thruster 1414 and may use a mixture of types of thrusters 1414 without departing from the scope of the disclosure. Although generally described as being rocket engines and motors, it is contemplated that the one or more thrusters 1414 may be any thruster, such as ion thrusters, magnetic thruster, plasma thrusters, propellers, impellers, etc., and combinations thereof.

It is envisioned that the autonomous vehicles described herein may employ one or more of the movable flaps 414, the parachutes 914, and/or the thrusters 1414, and combinations thereof. If a combination of one or more of the movable flaps 414, the parachutes 914, and/or the thrusters 1414 is used, the autonomy computing system 300, in combination with the secondary braking module 340, may determine which, and how many, of the movable flaps 414, the parachutes 914, and/or the thrusters 1414 to utilize to decelerate the autonomous vehicle 100. The autonomy computing system 300 may consider atmospheric conditions (temperature, wind speed and direction, etc.), location, elevation, etc., and/or prioritize one modality over another based on economic factors. In one non-limiting example, the autonomy computing system 300 may stagger or otherwise determine an order in which the movable flaps 414, the parachutes 914, and/or the thrusters 1414 are deployed.

As can be appreciated, the movable flaps 414, the parachutes 914, and/or the thrusters 1414 do not need to bring the autonomous vehicle 100 to a complete stop. The movable flaps 414, the parachutes 914, and/or the thrusters 1414 are utilized to reduce the velocity of the autonomous vehicle 100 to the point where the dynamic friction between the tires of the autonomous vehicle 100 and the roadway 150 becomes an effective decelerant. The autonomy computing system 300 monitors the velocity of the autonomous vehicle 100 and may determine a threshold velocity value where the primary brakes of the autonomous vehicle 100 can be applied. The threshold velocity value may be based upon a weight or mass of the autonomous vehicle, atmospheric conditions, location, elevation, the type of roadway surface and the condition of the roadway surface, etc., and/or combinations thereof. As can be appreciated, by waiting to apply full braking power or modulating braking power during initial deceleration caused by the secondary braking modalities (e.g., the movable flaps 414, the parachutes 914, the thrusters 1414), heat buildup and other detrimental effects on the primary brakes of the autonomous vehicle 100 may be mitigated. Temperature and/or heat is a major contributor to degraded performance of braking systems, and by waiting to apply full braking power until the threshold velocity value is reached, the braking system is able to perform at a higher level, and cause the autonomous vehicle to stop quicker, as compared to engaging the braking system earlier or at a higher power level.

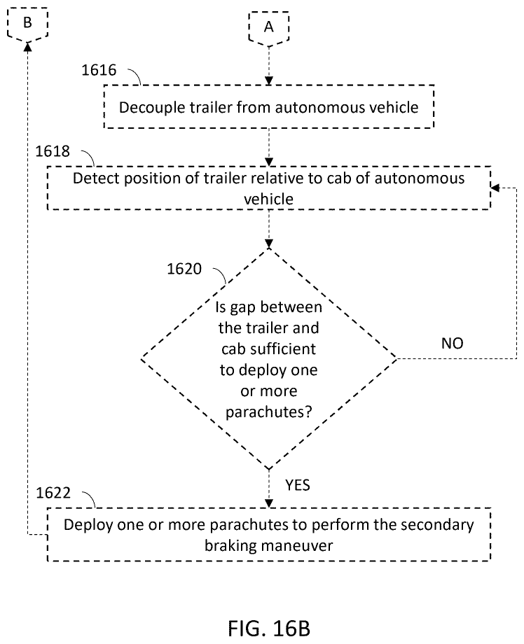

With reference to FIGS. 16A and 16B, a method of braking for an autonomous vehicle is illustrated and generally identified by reference numeral 1600. The autonomy computing system detects 1602 a velocity and momentum of the autonomous vehicle. In parallel, the autonomy computing system detects 1604 conditions on the road ahead of the autonomous vehicle and determines 1606 an emergency stopping distance for the autonomous vehicle at the detected velocity and momentum for the detected conditions of the road. Based on the determined emergency stopping distance and the detected conditions of the road ahead of the autonomous vehicle, the autonomy computing system determines 1608 if a potential collision between an object identified on the road ahead of the autonomous vehicle is imminent. If the autonomy computing system determines that there is no potential collision, the autonomy computing system continues to detect 1602 the velocity and momentum of the autonomous vehicle, detect 1604 conditions on the road ahead of the autonomous vehicle and determine 1606 an emergency stopping distance for the autonomous vehicle, and determining 1608 if a potential collision is imminent. If it is determined that and that a potential collision is imminent, the autonomy computing system engages the secondary braking module to determine 1610 a secondary braking distance that suggests the potential collision can be avoided if secondary braking is employed. The determination identifies which secondary braking modalities to deploy, how many secondary braking modalities to deploy, and/or an order in which the secondary braking modalities will be deployed. The secondary braking module deploys 1612 the determined secondary braking modalities to perform the secondary braking maneuver and the method ends 1614. In some embodiments, the secondary braking module decouples 1616 the trailer from the autonomous vehicle and detects 1618 a position of the trailer relative to the cabin. The secondary braking module determines 1620 if a gap between the trailer and the cabin is sufficient to deploy one or more parachutes without having the trailer interfere with the one or more parachutes. If the secondary braking module determines that the trailer is too close in proximity to the cabin, the secondary braking module continues to determine 1620 if the gap between the trailer and cabin is sufficient to deploy the one or more parachutes. If the secondary braking module determines that the gap between the trailer and the cabin is sufficient, the secondary emergency braking module deploys 1622 one or more parachutes to perform the secondary braking maneuver and the method ends 1614. As can be appreciated, the above-described method may be performed in any order and any number of times without departing from the scope of the disclosure.

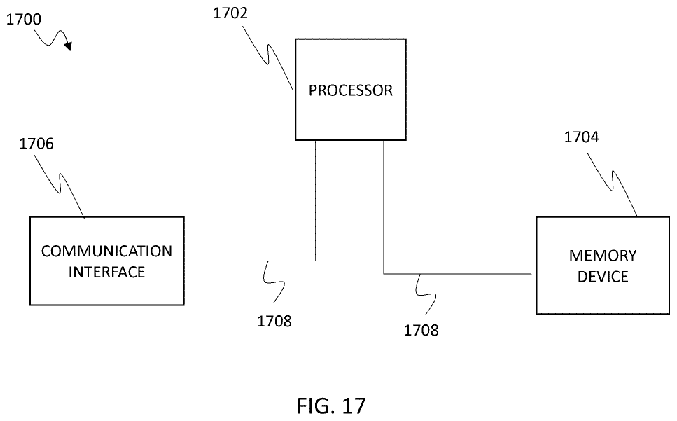

With reference to FIG. 17, a block diagram of an example computing device for implementation of embodiments of the disclosure is illustrated and generally identified by reference numeral 1700. Methods described herein may be implemented with one or more computing devices 1700. The autonomy computing system 300 may be implemented with one or more computing devices 1700. The computing device 1700 includes a processor 1702 and a memory device 1704. The processor 1702 is coupled to the memory device 1704 via a system bus 1708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are examples only, and thus are not intended to limit in any way the definition or meaning of the term “processor.”

The processor 1702 may be operatively coupled to a communication interface 1706 such that the computing device 1700 is capable of communicating with another device, such as for example, a remote application server, user equipment, a mobile device, a smart vehicle, a mission control or a central hub, another processing system, for example, using wireless communication or data transmission over one or more radio links or digital communication channels using one or more of a Wi-Fi protocol, an RFID protocol, or a Near-Field Communication (NFC) protocol, as one-way communication or two-way communication, or combinations thereof.

In the example embodiment, the memory device 1704 includes one or more devices that enable information, such as executable instructions or other data (e.g., sensor data), to be stored and retrieved. Moreover, the memory device 1704 includes one or more computer readable media, such as, without limitation, dynamic random-access memory (DRAM), static random-access memory (SRAM), a solid-state disk, or a hard disk. In the example embodiment, the memory device 1704 stores, without limitation, application source code, application object code, configuration data, additional input events, application states, assertion statements, validation results, or any other type of data. The computing device 1700 in the example embodiment, may also include a communications interface 1706 that is coupled to the processor 1702 via the system bus 1708. Moreover, the communication interface 1706 is communicatively coupled to data acquisition devices.

In the example embodiment, the processor 1702 may be programmed by encoding an operation using one or more executable instructions and providing the executable instructions in the memory device 1704. In the example embodiment, the processor 1702 is programmed to select a plurality of measurements that are received from data acquisition devices.

In operation, a computer executed computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified, and in embodiments of the disclosure may include additional or fewer operations than those disclosed herein. For example, it is contemplated that executing or performing a particular operation before, contemporaneously with, or after another operation is within the scope of aspects of the disclosure.

In embodiments, the memory device 1704 may be external to the computing device 1700 and may be accessed by using a storage interface or the system but 1708. For example, the memory device 1708 may include a storage area network (SAN), a network attached storage (NAS) system, or multiple storage units such as, for example, hard disks and solid-state disks in a redundant array of inexpensive disks (RAID) configuration.

In some embodiments, the processor 1702 may be operatively coupled to the memory device 1704 via the system bus 1708. It is envisioned that the system bus 1708 may be any component capable of providing the processor 1702 with access to the memory device 1704. In embodiments, the system bus 1708 may include, for example, an Advanced Technology Attachment (ATA) adapter, a Serial ATA (SATA) adapter, a Small Computer System Interface (SCSI) adapter, a RAID controller, a SAN adapter, a network adapter, or any component providing the processor 1702 with access to the memory device 1704.

An example technical effect of the methods, systems, and apparatus described herein includes at least one of: (a) a secondary braking system that reduces a braking distance when compared to vehicles having only a primary braking system, (b) a secondary braking system that reduces wear and tear on a primary braking system of the vehicle, (c) control of deployment of the secondary braking system based on signals from sensors of the autonomous vehicle, (d) flaps for decelerating the autonomous vehicle, (e) flaps on an uncrewed cabin that provides increased areas for placement of the flaps, compared to a crewed cabin, or (f) an aerodynamic shape of an uncrewed cabin for decelerating the autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, module, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination or instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via nay suitable means including memory sharing, message passing, token passing, network transmission, etc.

The actual software code or specialized control hardware used to implement these systems and methods is not limited of the claimed features or this disclosure. Thus, the operations and behavior of the systems and methods were described without reference to the specific software code being understood that software and control hardware may be designed to implement the systems and methods based on the description herein.

When implemented in software, the disclosure functions may be embodied, or stored, as one or more instructions or code on or in memory. In the embodiments described herein, memory includes non-statutory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomous vehicle selectively couplable to a trailer, comprising:
a cabin;
at least one sensor coupled with the cabin and configured to capture signals of an environment in which the autonomous vehicle is operating;
a secondary braking system operably coupled to the at least one sensor and supplemental to a primary braking system of the autonomous vehicle, the secondary braking system comprising:
one or more movable flaps disposed on the cabin, the one or more movable flaps positionable between a first, undeployed position and a second, deployed position, wherein the one or more movable flaps are configured to engage air surrounding the autonomous vehicle to increase drag to the autonomous vehicle and decelerate the autonomous vehicle; and
an autonomy computing system comprising at least one processor in communication with at least one memory device, the autonomy computing system housed in the cabin, and the at least one processor programmed to:
operate the one or more movable flaps, based on signals received from the at least one sensor.

2. The autonomous vehicle according to claim 1, wherein the cabin is an uncrewed cabin, the one or more movable flaps positioned on a front surface of the cabin.

3. The autonomous vehicle according to claim 2, wherein the cabin is aerodynamically shaped, the one or more movable flaps distributed over an exterior surface of the cabin.

4. The autonomous vehicle according to claim 3, wherein the one or more movable flaps at the first, undeployed position conform with an exterior surface of the cabin, and wherein the one or more movable flaps at the second, deployed position formed into a pine cone shape.

5. The autonomous vehicle according to claim 1, wherein the cabin comprises a top portion having an aerodynamic shape.

6. The autonomous vehicle according to claim 5, wherein the cabin is positionable between a first, undeployed position and a second, deployed position, and at the second, deployed position, the cabin is configured to increase the drag from the air to the autonomous vehicle.

7. The autonomous vehicle according to claim 1, wherein the one or more movable flaps are position at a top surface of the cabin and configured to deploy upward away from the autonomous vehicle.

8. The autonomous vehicle according to claim 1, wherein the one or more movable flaps are dynamic cabin extenders.

9. The autonomous vehicle according to claim 1, wherein at least one movable flap is positioned on the autonomous vehicle to direct air flowing over the at least one movable flap towards a void formed between the cabin and the trailer coupled to the autonomous vehicle.

10. The autonomous vehicle according to claim 1, wherein a geometry of at least one of the one or more movable flaps is based upon a location of the at least one movable flap on the cabin.

11. The autonomous vehicle according to claim 1, wherein the secondary braking system further comprises:
at least one parachute operably coupled to the autonomous vehicle, the at least one parachute selectively deployable from a first, undeployed configuration to a second, deployed configuration,
wherein the at least one processor is further programmed to:
operate the at least one parachute based on the signals received from the at least one sensor.

12. The autonomous vehicle according to claim 11, wherein at least one parachute is disposed on the autonomous vehicle at a position, when transitioning from the first, undeployed configuration to the second, deployed configuration, that avoids being entangled with a trailer coupled to the autonomous vehicle.

13. The autonomous vehicle according to claim 11, wherein the at least one processor is further programmed to:
monitor, using the at least one sensor, deployment of the at least one parachute; and
control the deployment of the at least one parachute to avoid being entangled with a trailer coupled to the autonomous vehicle.

14. The autonomous vehicle according to claim 11, wherein the at least one parachute includes a pilot chute that delays deployment of the at least one parachute.

15. The autonomous vehicle according to claim 1, wherein the at least one processor is further programmed to:
detach the trailer from being coupled with the cabin.

16. The autonomous vehicle according to claim 1, wherein the secondary braking system further comprises one or more thrusters operably coupled to the cabin, the one or more thrusters oriented to direct thrust in a direction opposite a direction that the autonomous vehicle is travelling to decelerate the autonomous vehicle.

17. A method for supplementally braking an autonomous vehicle, the method comprising:
installing a secondary braking system, supplemental to a primary braking system of the autonomous vehicle, the secondary braking system including:
one or more movable flaps disposed on a cabin of the autonomous vehicle, the one or more movable flaps positionable between a first, undeployed position and a second, deployed position, wherein the one or more movable flaps are configured to engage air surrounding the autonomous vehicle to increase drag to the autonomous vehicle and decelerate the autonomous vehicle; and
operating, via an autonomy computing system of the autonomous vehicle, the one or more movable flaps, based on signals received from at least one sensor of the autonomous vehicle.

18. The method according to claim 17, wherein the cabin is an uncrewed cabin and installing the secondary braking system further comprising:
positioning the one or more movable flaps on a front surface of the cabin, wherein positioning the one or more movable flaps at the first, undeployed position causes the one or more movable flaps to conform with an exterior surface of the cabin, wherein positioning the one or more movable flaps at the second, deployed position causes the one or more movable flaps to form into a pine cone shape.

19. The method of claim 17, wherein installing the secondary braking system further comprises:
installing an airfoil to the cabin, the airfoil having an aerodynamic shape, wherein the cabin is positionable between a first, undeployed position and a second, deployed position, and at the second deployed position, the cabin is configured to increase the drag from the air to the autonomous vehicle.

20. The method according to claim 17, further comprising:
detecting, via one or more sensors operably coupled to the autonomous vehicle, a velocity and momentum of the autonomous vehicle;
detecting, via the one or more sensors, conditions on a roadway ahead of the autonomous vehicle;
determining, based on the detected velocity and momentum of the autonomous vehicle and the detected conditions on the roadway, an emergency stopping distance for the autonomous vehicle;
determining, based on the determined emergency stopping distance and the detected conditions on the roadway, a potential collision between the autonomous vehicle and an object identified on the roadway is imminent; and
deploying the secondary braking system of the autonomous vehicle, to perform an emergency braking maneuver.
